(19) United States
(12) Patent Application Publication
(10) Pub. No.: US 2007/0151962 A1
(43) Pub. Date: Jul. 5, 2007

(54) Method for laser-induced thermal separation of plate glass

(76) Inventors: Walter Doll, Reute (DE); Rainer Kolloff, Breisach (DE); Horst Kordisch, Botzingen (DE); Rainer Kubler, Freiburg (DE); Gerd Spiess, Freiburg (DE); Wolfgang Friedl, Kaisheim (DE); Siegfried Glaser, Beverungen (DE); Manfred Pohler, Klein Rosenburg (DE)

Correspondence Address: KLAUS J. BACH, 4407 TWIN OAKS DRIVE, MURRYSVILLE, PA, 15668, US

(21) Appl. No.: 11/526,897

(22) Filed: Sep. 22, 2006

Related U.S. Application Data
(63) Continuation-in-part of application No. PCT/DE05/00509, filed on Mar. 18, 2005.

(30) Foreign Application Priority Data
Mar. 22, 2004 (DE) 10 2004 014 277.7

(51) Int. Cl. B23K 26/38

(52) U.S. Cl. 219/121.72; 225/2

(57) ABSTRACT

In a method for a laser-induced thermal separation of plate glass by thermal scoring using a laser beam heating the glass along a desired separation line with subsequent cooling of the laser-heated line, wherein the heat is applied by the laser beam in a number of repetitive passes at intensities based on glass thickness and desired cutting speeds.

This is a Continuation-In-Part Application of International PCT/DE2005/000509 filed Mar. 18, 2005 and claiming the priority of German application 10 2004 014 277.7 filed Mar. 22, 2004.

### BACKGROUND OF THE INVENTION

The invention relates to a low-damage separation of flat glass sheets wherein a laser is used for a thermal scoring of the glass sheets.

Flat glass sheets are separated still today by scoring with a score wheel and subsequent bending breakage. The required mechanical damaging of the glass surface over the full length of the desired separation line by the score wheel results in the formation of recesses and chips of the glass along the edge thereof which results in a reduced edge strength. Glass chips and the use of cutting oil furthermore can be inconvenient for subsequent treatment procedures such as coating so that the edge area must subsequently be treated by expensive, time-consuming processes such as edging, grinding and washing.

As is well known, glass sheets can be provided with a surface start-out fracture of an excellent quality by thermally-induced stresses, which avoids the disadvantages described. To this end, the area in which the fracture is to develop is locally heated and locally cooled after formation of a very small surface score, for example by Vickers impression. This method has been used, for example, by Fraunhofer IWM in their historical examinations concerning breakage processes of glasses: F. Kerkhoff “Ein einfacher Versuch zur Bruchflächenmarkierung durch mechanische Impulse [A simple test for marking breakage surfaces by mechanical impulses]” Glastechn. Bericht 28, pages 57/58 (1955); F. Kerkhof: “Bruchvorgänge in Gläsern [breakage processes in glasses]” Verlag der Deutschen Glastechnischen Gesellschaft, Frankfurt/Main, (1970). The heating method employed thin flames or hot air blowers; cooling was implemented with water or air/water mixtures.

In the German patent publication DE 28 13 302, a method and an apparatus for the straight-line cutting of flat glass sheets with the aid of thermally induced tensions is described, by which glass plates can be cut along straight lines by heating and subsequent cooling at constant subsequent geometric spacing. Also, thick glass (20 mm) can be cut, however only at speeds of up to 0.5 m/min. Since it involves open cuts, the cut position is limited essentially to center cuts, since otherwise, edge effects occur, which result in an unstable fracture extension with serious deviations from the desired line.

The use of a laser for thermal scoring with high accuracy along a desired line is disclosed in U.S. Pat. No. 5,609,284. The lasers used have such wavelengths that the radiation is absorbed at the surface of the glass, preferably CO₂ lasers (10.6 μm). With the laser, an elliptical heat spot is generated on the glass surface and is moved at an advancement speed v symmetrically along the desired separation line; cooling follows at a geometrically constant distance L, wherein the score is established below the cooled surface. The particular feature of this U.S. Pat. No. 5,609,284, is that it indicates a correlation between the advancement speed v and the score depth δ, that is,
v=k·a(b+L)/δ
Wherein, a, b are geometric parameters of the elliptic heat spot, L is the distance of the heat source from the cooling spot and k is a proportionality constant. The thicknesses of the cut glass are between 1.2 mm and 6 mm the achievable maximum cutting speed is about 1 m/min.

Since during a cutting process, the parameters a, b, L and k are constant, it is apparent from the above equation that the achievable score depth δ is inversely proportional to the cutting speed v. The higher the selected cutting speed, the lower is the resulting score depth. It is well known however that, with a small score depth, the subsequent breaking procedure becomes more difficult resulting in a deterioration of the edge quality. In accordance with U.S. Pat. No. 5,609,284, thicker glass plates with lower cutting speeds, that is, cutting speeds with substantially less than 1 m/min, result in flat fractures so that the subsequent separation process becomes quite difficult. This is presumably also the reason why no separating example for glass plates with thicknesses of more than 6 mm were given. Concerning the span b of the elliptical heat source in cutting direction a ratio of the glass thickness h of 1≦b/h≦20 is recommended since, with respect to b<h, the resulting cutting speed is too low and with b>10 the cutting accuracy deteriorates. It is also to be noted that the elliptical shape of the heat source and the geometrically constant distance between the heat source and the cooling nozzle can result in substantial disadvantages in the cutting of curves. This becomes particularly noticeable in connection with smaller radii by deviations of the cutting curve from the desired line.

It is the object of the present invention to apply thermal scores to glass plates along predetermined desired lines at a high speed in order to facilitate higher cutting speeds (substantially over 1 m/min). In particular, the separation also of glass plates of larger thicknesses should be facilitated particularly also a sufficiently deep scoring of very thick glass plates (ca. 20 mm) should be made possible. In addition, all this should be possible while cutting curved lines.

### SUMMARY OF THE INVENTION

In a method for a laser-induced thermal separation of plate glass by thermal scoring using a laser beam heating the glass along a desired separation line with subsequent cooling of the laser-heated line, wherein the heat is applied by the laser beam in a number of repetitive passes at intensities based on glass thickness and desired cutting speeds.

Overcoming the problems left unsolved so far is very important for the technical application. Float glasses for example are manufactured with a thickness of about 1 mm to about 20 mm, wherein the advancing speed of the glass web during manufacture depending on the glass thickness (as well as the capacity of the melting furnace) is between 30 m/min and 2 m/min. These advancing speeds exceed by far the possible cutting speeds according to U.S. Pat. No. 5,609,284, so that the glass plates can not be separated in accordance with the manufacturing speed of the glass web.

First, the solution pathway according to the invention takes glass-specific damaging aspects into consideration and derives therefrom avoidance teachings, a pre-condition which must be fulfilled for generating cutting areas of high quality. An increase of the cutting speed by increasing the applied laser energy is limited by the formation of transverse fractures and melting. These transverse fractures are small stress fractures which extend transverse to the score line. Since such stress fractures as well as melting must be avoided, only a certain maximum energy per time unit and per area, or, respectively, glass (volume) element can be supplied to the glass with the rapid energy supply needed with regard to the high cutting speeds. This is a material-specific value which is dependent on the type of glass such as (calcium-natron-) float glass, boron-float glass and the coloring of the glass and, if applicable, also the manufacturing conditions. For float glass, experimentally, an upper limit value S_{g} of 0.016 Watts×seconds/mm² has been determined. As a result, a predetermined surface element must not be subjected uninterruptedly to more heat than the upper limit value, since otherwise transverse fractures and melting would occur.

In order to make it possible to input more heat into an area element without causing damage, the heat must be applied repeatedly with appropriate pauses. During the pauses, the radiation energy absorbed at the surface can be at least partially conducted into the interior of the material and distributed therein. In this way, the surface temperature is substantially reduced as apparent from theoretical considerations. The accurate length of the needed pauses depends on the type of glass and also the temperature of the glass reached at the surface thereof. For float glass, the experiments performed therewith indicate that, with maximum energy application corresponding to the upper limit value of 0.016 watt×seconds/mm², a pause of only about 50 milliseconds is very efficient. Longer pauses are possible but inefficient with regard to a higher cutting speed, shorter pauses require a reduced energy input in comparison with the upper limit value in order to avoid the damages described. For a technical application, this means that the heat input must be repetitive and very fast. For the technical implementation of the desired rapid movement of the laser beam spot, scan systems may be used which are capable of realizing scan speeds in the area of over 100 m/s. Furthermore, the computer-based control of the scan systems have the advantage that any desired curves can be produced permitting the cutting of any desired format.

The scanning speed at which the beam spot is moved over the glass surface for a particular application can be calculated from the upper limit value taking into consideration the beam spot diameter and the power of the laser. The length of the heated stretch of the desired cutting line is determined from the selected pause time and the scanning speed of the heat source.

Advantageously, the length of the heating stretch and the scanning speed with which the laser beam moves over this stretch are so selected that the time required herefor corresponds to the required pause time so that no additional waiting time needs to be observed for the execution other than, for example, the 0.05 seconds required in connection with floating glass.

The number of repetitions co-determines the achievable score depth and is dependent on the glass type and particularly on the glass thickness wherein there are minimum and maximum limits outside of which the result is ineffective or even damaging. For example, with thin glass, fewer repetitions are necessary than with thicker glass.

Instead of applying only a single heat track, several heat tracks (line packet) can be employed which extend parallel or which, respectively, are in close vicinity and preferably symmetrically with respect to the desired separation line. It is to be noted in this connection that a greater width of the line package then 12 to 15 mm will hardly result in a further increase of the stresses. It is however advantageous to work with an uneven number of lines in the package in such a way that one line follows exactly the desired separation line and furthermore to provide for a scanning cycle (the order of scanning) of the lines such that this center is scanned twice in comparison with the other lines. In this way, the center line is given the task of a guide line, which is very important for the cut quality. For a line packet, it is necessary to work with a preheating stretch which is correspondingly shorter in comparison with a single line if comparable conditions are desired.

In order to be able to score longer or continuous separation lines whose length exceeds the length of the heating stretch calculated in this way, each repetition is extended in the direction of the desired line to be scored by an advancement increment Δx. The incremental length Δx is derived from the desired cutting speed v and the number of the repetitions N. This applies to the steady state, that is continuous, operation. At the beginning and at the end of a cut, it is more advantageous to provide for a stepped heating in such a form that these stretches are subjected to the same heat-up conditions as those under steady state operation.

Shortly before the beginning of the heating of the initial heating stretch or before the end of the heating stretch, a fine score is applied to the desired separation line, specifically from, or next to, the start-out point by means of a scoring diamond or a scoring wheel. Then the cooling nozzle is started at the score point and is moved over the heated desired separation line at cutting speed. As a result of the cooling effect stresses occur in the surface area of the glass, which are effective normal to the desired separation line and become smaller over the thickness of the glass. As a result of the stresses, a fracture is initiated and advanced at the speed of the movement of the cooling nozzle.

Below the invention will be described in greater detail on the basis of the accompanying drawings.

### BRIEF DESCRIPTION OF THE DRAWINGS

FIG. 1 shows schematically the generation of the laser-score along a desired separation line on a glass plate,

FIG. 2 is an enlarged cross-sectional view of an area of a glass plate taken along the line II-II of FIG. 1, wherein the tension conditions in the glass along the desired separation line are shown,

FIG. 3 is an enlarged cross-sectional view of an area of the glass plate taken along the line III-III of FIG. 1, which shows the tension conditions over the glass thickness after the coating effects,

FIG. 4 shows in a schematic representation the arrangement in principle of a device for performing the method according to the invention,

FIG. 5 is a diagram, which shows the relation between laser power and beam spot diameter in connection with the scanning speed,

FIG. 6 is a graph, which shows the relationship between score depth on glass thickness for various score speeds,

FIG. 7 shows schematically the course of cutting an oblong plate,

FIG. 8 shows schematically the way of cutting a mirror of an oblong basic form with a semicircular form at one end,

FIG. 9 shows the cutting of abutting glass plates of flat glass panels, and

FIG. 10 shows the separation of an edge strip from a glass plate.

### DESCRIPTION OF PREFERRED EMBODIMENTS

FIG. 1 shows schematically in a perspective representation a glass plate on which a score is formed along a desired separation line by the method according to the invention. The desired separation line is shown by a dotted line, the location of the start-out score (mechanical damage at the start-out score point) is indicated, the heating stretch, which has been repetitively scanned by the laser beam, is indicated by a dash-dotted line, the cooling nozzle disposed behind the heating stretch is indicated. The start-out crack already formed in the glass (in the area of the stretch already passed by the cooling nozzle) is shown hatched.

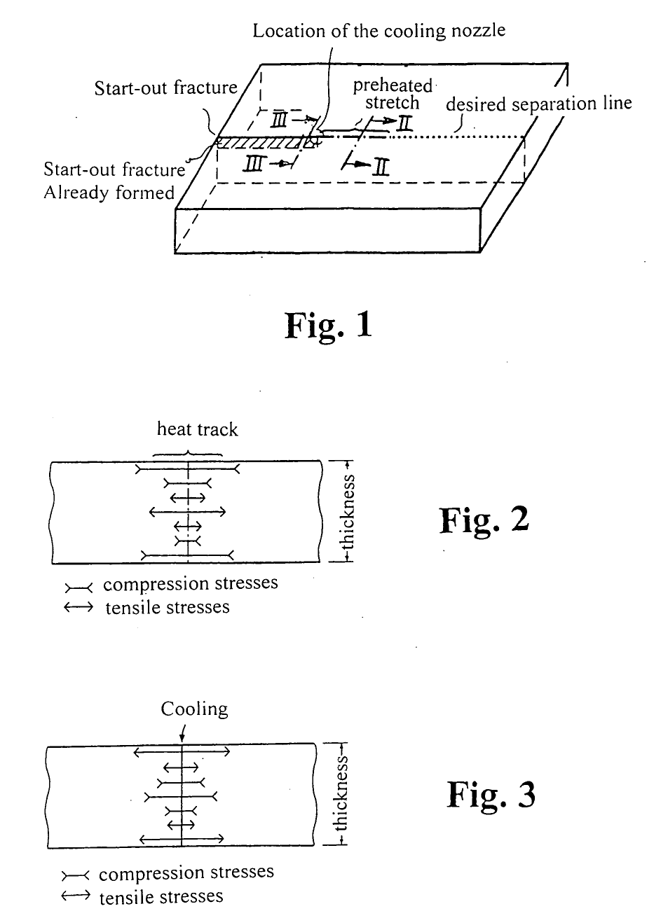

The FIGS. 2 and 3 show the stress conditions in the glass cross-section in the area of the desired separation line at the heating stretch (FIG. 2) in the area of cooling by the cooling nozzle (FIG. 3). The location and the extent of the compressive stresses and the tensile stresses is indicated over the thickness of the glass. Viewed over the glass thickness, there are in each case three-part stress fields, specifically, in the area of the heated zone there are compression-tensile-compression stresses and in the cooled area there are tensile-, compression-, tensile stresses, that is, tensile stresses are present at the surface and also at the opposite face area. The surface fractures are caused by the tensile stresses. In the start out fracture area, the stresses are mostly eliminated.

The cutting accuracy, that is the exact results of the starter score along the desired separation line, is determined essentially by the heat field applied, but it can also be influenced by the cooling. For the cutting accuracy, a heat distribution normal to the desired separation line and also normal to the area has been found to be advantageous wherein, expediently, a heat maximum should be present in the center that is exactly on the desired separation line.

During curved-line separation, particular with narrow curves, it has been found to be advantageous for a good cutting accuracy if the heat profile is rotationally symmetrical with respect to the line which is normal to the surface area of the glass to be separated in addition to the requirements mentioned.

As already mentioned, a particularly good cutting accuracy is obtained if a well-defined maximum of the heat distribution is disposed exactly on the desired separation line. Instead, by a corresponding distribution of the light intensity of the radiation source, this can be achieved technically easily and more efficiently and, furthermore, in a variable way with the aid of scanners. The measure to achieve this has been described in principle already for a scanning line packet. With a single scanning line, this is achieved, for example, by the application of an additional heat line with a smaller beam spot diameter (and if appropriate smaller energy) exactly on the desired separation line. In this way, a guideline feature is provided. Such a guideline must be applied at least once along the repetition length and this occurs, on a time basis, most favorably just before the repetition length has been worked off. Herein, the laser application to the guideline must also occur backwardly so that all partial stretches of the guideline are continuously joined. For technical application, it is necessary that the focus position of the line is rapidly displaceable and also the scanner is appropriately programmed. In this connection, it can be particularly advantageous to operate along the guide line with variable laser power. The cooling should occur as effectively as possible, for example, by spraying an air/water mixture onto the glass surface; the cooling should also be as uniformly symmetrical as possible relative to the separation line. A weak cooling results in a reduction of the achievable score depth, wherein, in a border case, no score occurs. On the other hand, an excessive cooling may result in inaccuracies in the cutting line and, therefore, in irregular deviations from the desired separation line.

An effect of the method according to the invention, which was totally unexpected even by person skilled in the art, is highly important for the cutting of formats. This concerns the more or less perpendicular crossing of scores.

From examinations concerning the travel of fractures in glass, it is known that a fracture, which meets more or less perpendicularly a fracture that is already present, is stopped at this point. This knowledge is utilized in damage analyses for distinguishing primary cracks from secondary cracks in order to reconstruct the crack occurrence and the reason for breakages. The more astonishing is the finding that cracks already present on a glass surface can be crossed over by laser-induced scores without the need for applying an additional mechanical damage to the opposite crack edge. A subsequent microscopic inspection of the fracture area does not show any additional damage. This can be utilized for cutting formats with rectangular corner areas without damage.

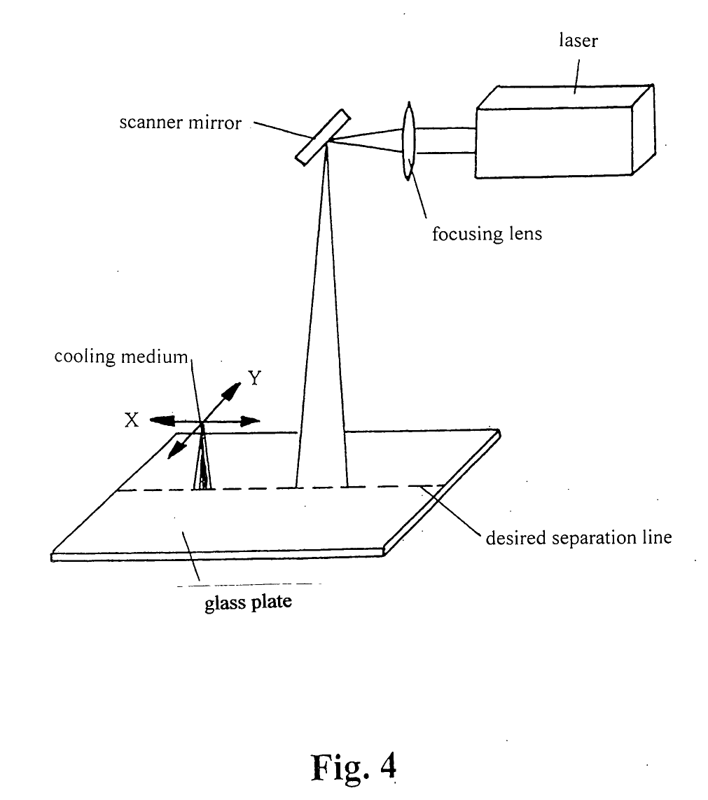

FIG. 4 shows schematically the principle of an arrangement for cutting flat glass plates. The glass plate to be separated is disposed on a cutting table (not shown), which is equipped with an x-y bridge (not shown). The x-y bridge, on which the scoring diamond and the cooling device are mounted, moves in a plane (x-y) above, and parallel to, the glass plate. CNC-controlled it can move along any curve predetermined for the score diamond and the cooling device. The travel speed of the x-y bridge is up to 60 m/min. Above the cutting table, a laser and a scanner are so arranged that the laser beam can scan on the glass plate a field of for example 1×1 m² surface area. Via the lens, or respectively, an electronic correction a distortion-free image can be obtained. The diameter of the laser beam striking the glass surface which is called herein the beam spot diameter can be reduced or enlarged by means of the electromagnetically movable focusing lens and this can be done in a very short line in the range of 1 mm to 20 mm.

As laser in this method, which operates essentially by surface heating, preferably lasers are used whose light wavelength is above the absorption edge of the glass, that is, which is greater than 2.8 μm. Because of their reasonable prices and technical maturity, CO₂ lasers were used. The lasers used had 200 watt and 630 watt (wavelength 10.6 μm). These are so-called c_{w} lasers, that is, lasers which work continuously and not in the modulated impulse mode. For the processing of glass, this is particularly advantageous since in this way during impulse operation Schrenn fractures, which are easily generated by impulse peaks, can be avoided.

For the cutting of larger (longer) glass plates, the glass plates can be moved on the cutting table in x-direction under CNC control.

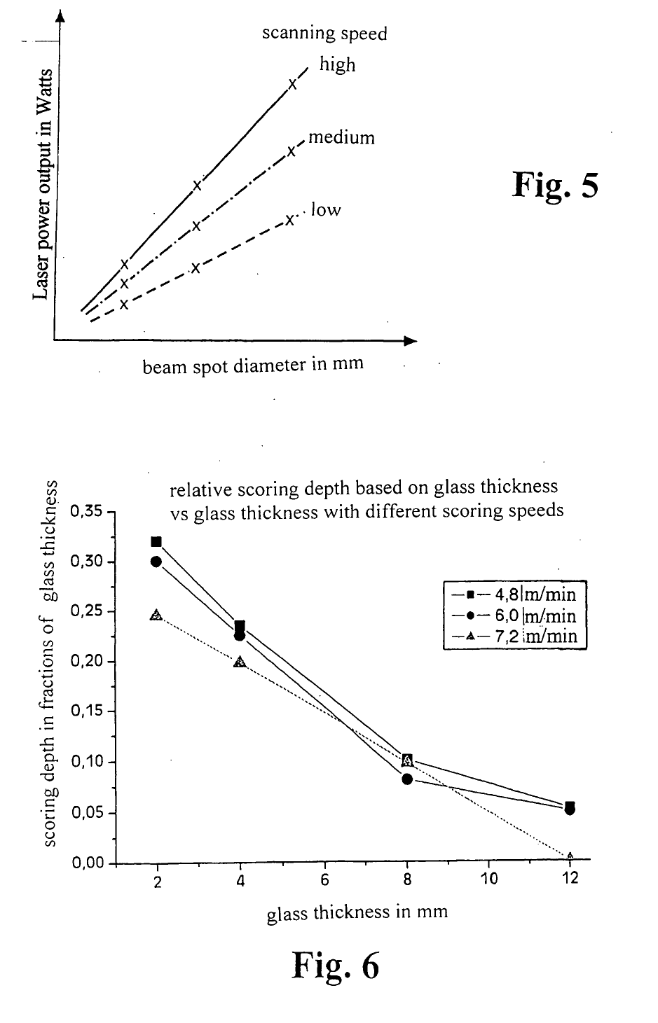

If glass or glass types must be cut whose limit values S_{g} for the danger for the formation of Schrenn fractures are not known, those dangers are determined in a preliminary test. During such a test, heat tracks with different laser power and different beam spot diameters are applied to the surface of the glass to be examined at various speeds. In each case, only one parameter, for example the laser power, is increased until Schrenn fractures are formed. Then, the influence of the other parameters is examined. In the end, the result shown schematically in FIG. 5 is obtained, which is shown here for three different scanning speeds. With parameter values above the respective limit, straight-line Schrenn fractures are formed. It is recognized that, for example with a constant beam spot diameter, heat can be applied at high scanning speeds with greater laser power output than at lower scanning speeds, without the occurrence of Schrenn fractures. From the inclination of the straight line, the limit value Sg (as energy per area unit) the Schrenn fracture formation is determined via the formula

$${S}_{q} = \frac{{P}_{1}}{{d}_{1} {V}_{5}} \qquad ( 1 )$$

wherein P₁=laser power, d=beam spot diameter, vₛ=scanning speed of the laser beam.

It should be taken into consideration that the limit value S_{q} determined in this way does not only depend on the glass type but also on the energy distribution within the laser beam. For a symmetrical laser beam with the energy maximum in the center (with Gauss-distribution), for float glass a limit value S_{g}=0.0016 watts*s/min² has been determined.

This limit value S_{g}, at which the formation of Schrenn-fractures is just avoided applies to the case of a single application to the glass surface of the laser beam with the respective parameters P₁d₁Vₛ. An immediately repeated application of a laser beam to the heating stretch l with these parameters results in the formation of Schrenn fractures since the additional thermal stress is excessive.

The thermal stress can be reduced by a change of the parameters with a reduced limit value S_{g} or—and this is the general solution—by the introduction of pauses tₚ. The pause duration tₚ can easily be determined experimentally by observing the Schrenn fracture formation during repeated scanning with different delay times. For float glass, the necessary pause duration tₚ was determined to be 50 milliseconds, if the glass surface was exposed to the maximally possible, but still damage-free, conditions in accordance with equation (1).

It is noted that the repeated examinations have shown that, with increasing heating of the heating stretch, that is, with increasing repetitions of the laser scan, also the necessary duration of the pauses becomes smaller. This can be utilized for a further increase of the efficiency of the laser treatment procedure.

Above, the conditions are described under which the formation of Schrenn fractures can be avoided. However, the energy input obtained in this way with a single laser exposure to the glass surface and the temperature and tension field generated thereby is generally not sufficient to produce a starting fracture at the desired high cutting speeds. Therefore, a so-called heating stretch of the length l is respectively subjected N-times to the laser beam. Since the heating stretch l is subsequently passed over at the cutting speed v, the following applies:
L/v=N·tₚ (2)
or in the case of float glass with a pause duration tₚ=0.053,
L=0.05N·v (2a)

The heating stretch l, the number of repetitions N and the cutting speed v are interdependent via the equation (2a).

For the separation of longer stretches, after each laser beam application, the heating stretch is advanced by an advancing increment Δx along the desired cutting line wherein:
Δx=l/N (3)

or, for float glass:
Δx=0.05v (3a)

For the formation of start-out fractures, for different glass types, material-specific aspects must be taken into consideration, which can be determined experimentally. This will be demonstrated below on the basis of cutting examples.

From float glass plates of different thicknesses (2, 4, 8 and 12 mm) having the dimensions 80×80 cm², 5 cm wide strips were separated in that, at different cutting speeds v, first surface fractures were generated and the glass strips were then broken off by bending. The surface startup fractures were induced by a 630 watt CO₂ laser beam at the following parameters: 100% power output, about 4.2 mm beam spot diameter, length of the heating stretch 1=360 mm, scanning speed of the laser beam vₛ=12 m/sec, cooling speeds v of 4.8 m/min, 6 m/min and 7.2 m/min. The respective increment Δx of the heating stretch was 4 mm, 5 mm, 6 mm, whereas the number N of the repetitions of the laser applications was reduced from 90 to 72 and then to 60. (The energetic conditions were so designed, that operation occurred barely below the limit value for the Schrenn fracture formation.) In the breakage areas, the respective start-out fracture depth was measured and plotted in FIG. 6 in a normal form as a function of the glass thickness. It is to be noted that, with a glass plate of 12 mm thickness and at a 7.2 m/min cooling speed, no start-out fracture could be generated under the given energetic conditions. Generally, it shows that the generated relative start-out fracture depth becomes smaller with increasing glass thickness. With even greater glass thicknesses or, respectively, high cooling speeds, under the selected energy and the resulting stress conditions, no start out fractures whatsoever could be generated. In order to still be able to obtain deeper start-out fractures and in this way to effectively cut also glass of greater thickness, the following technical measures have been found to be successful.

1. Working with a laser of higher power output P₁. In this case, the equation (1) must be taken into consideration and, in accordance therewith, the beam spot diameter d must be increased (This measure can also be used for increasing the cutting speed).

2. Working with a higher energy input in that, with a constant heating stretch l, the number of repetitions N is increased, which requires a reduction in the incremental length Δx. This, of course, also results in a corresponding reduction of the cutting speed.

3. The application of additional pre-heating.

Since the effect of the measure 1 is evident, only the effects of measures 2 and 3 are explained on the basis of examples.

The measure 2, that is, an increase of the energy input by increasing the repetition rate from 90 to 180, particularly in connection with glass of 12 mm thickness, results in a noticeable increase in the depth of the start-out score as shown in the table below:

| | | | | | Start out score depth | |
|---|---|---|---|---|---|---|
| | | | | | 8 mm | 12 mm |
| | v | Δx | | L | glass | glass |
| | m/min | mm | N | mm | mm | mm |
| Start-out | 4.8 | 4 | 90 | 360 | 0.8 | 0.6 |
| situation | | | | | | |
| Measure 2 | 2.4 | 2 | 180 | 360 | 1.0 | 1.2 |

For this greater start out score depth resulting from an increase of the repetitions N, however, under otherwise identical laser operating conditions, the cutting speed of 4.8 m/min must be decreased to 2.4 m/min as well as the length of the increment Δx must be reduced from 4 mm to 2 mm.

The measure 3, that is, additional preheating, has been found to be very efficient in connection with thicker glass plates specifically with respect to a larger start-out score depth as well as an increase in the cutting speed. For glass plates of different thickness a straight desired cutting line was heated with a laser power output reduced to 80%, a beam spot diameter increased to about 4.0 mm and a scanning length, which was increased to 480 mm and different repetitions N. The actual start-out fracture generation was subsequently performed with again reduced beam spot diameter in order to have a guide line. With glass plates of greater thicknesses (8 and 12 mm), a heating with 140 repetitions was found so effective that for the subsequent application of the guide line, only 32 repetitions were sufficient to achieve relative start-out fracture depths of 0.1 or respectively, 0.06 (based on the glass thickness) and to achieve this at cutting speeds of 15 m/min which were not reached before. With thinner glass plates (2 and 4 mm) substantially fewer heating repetitions, N=40, 80, were sufficient to achieve a cutting speed of 15 m/min.

A further measure, that is, an additional waiting time after the heating, particularly in connection with thicker glass (thickness=larger than mm) make deeper start-out fractures possible. On a glass plate of 18.5 mm thickness using a laser power output of 630 watts, a scanning length l of 360 mm, Δx=1 mm, scanning speed of 12 m/sec, a beam spot diameter of 4 mm at 360 repetitions and a cooling speed of 1.2 m/min, the following has been obtained:

| Waiting time | Score depth |
|---|---|
| 0 seconds | hardly any depth |
| 20 seconds | 2.2 mm |

With thicker glass plates, the waiting time is minimal since otherwise a bending of the scoring is the result whereby the quality of the break area deteriorates. If a thickness-dependent waiting time is maintained, wherein the glass plate thickness in millimeter corresponds to an associated waiting time in seconds, very good and high quality star-out fracture depths are obtained.

However, a clear extension of the waiting times results in a reduction of the score depth, that is, it is counter-productive. This measure does not apply to thin glass sheets (thickness less than 4 mm) here and the use of waiting times is ineffective.

Below, several examples for the application of the separating method according to the invention are provided:

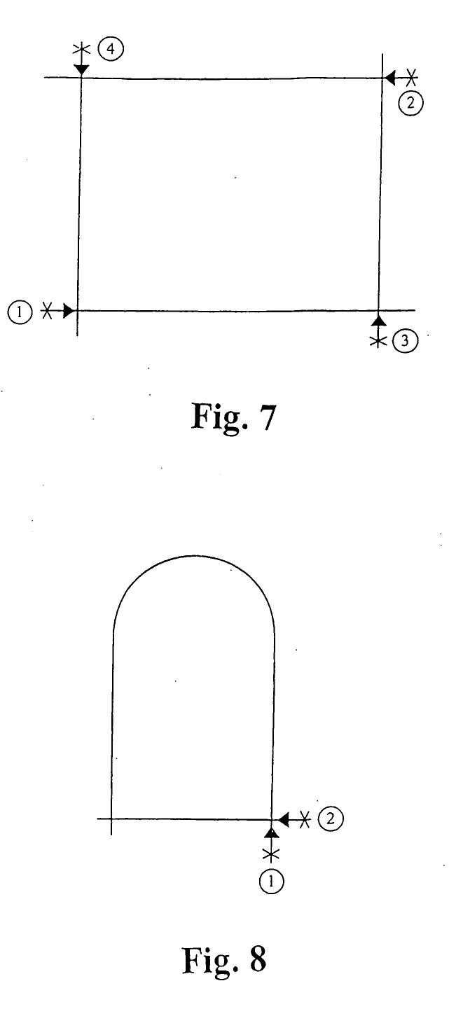

a) A rectangular plate of 100 cm×100 cm was cut from a 12 mm thick float glass plate. FIG. 7 shows the order, the direction, the start-out score points (each one marked by “X”); the distance of the start-out score points from the actual begin of the separation line is shown excessively large for clarity reasons (normally a few millimeters are sufficient). Particularly with small formats, the order of the cuts is very important in order to minimize the influence of the heat lines being applied on the heat lines already applied. Therefore, as shown by the example, heat lines, which in each case are as distant as possible, are to be applied in order to utilize the coating of the heat lines already applied.

The following cutting parameters were used:

| | | |
|---|---|---|
| Scoring speed | 6 | m/min |
| Laser power output | 580 | watts |
| Scanning speed | 9.6 | m/sec |
| Beam spot diameter | ca. 4.0 | mm |
| Scan length | 480 | mm |
| Advancement increment | 6 | mm |

| | |
|---|---|
| Number of repetitions | 80 |

b) A mirror of 90 cm×60 cm with a semicircular end was cut from a 3.8 mm thick flat glass plate (FIG. 8). The start-out score points are indicated by X. The order of the cuts is numbered. The end points of the cutting lines were each several millimeters above the actual edge of the cut area as shown in FIG. 8.

| | | |
|---|---|---|
| Scoring speed | 10 | m/min |
| Laser power output | 600 | watts |
| Beam spot diameter | ca. 4.0 | mm |
| Scan length | 500 | mm |
| Advancement increment | 8.3 | mm |

| | |
|---|---|
| Number of repetitions | 60 |

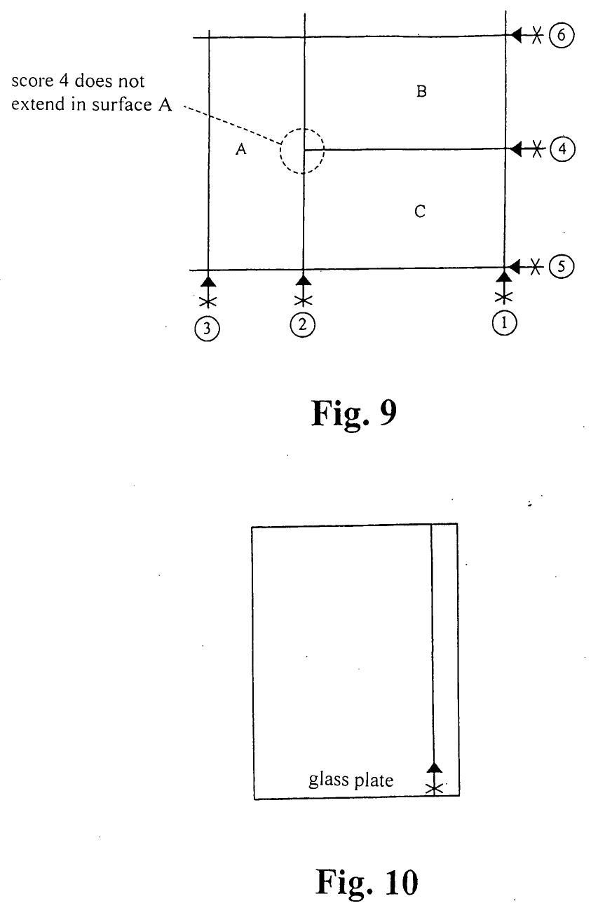

c) FIG. 9 shows an example for cutting several glass plates with common cutting lines and differently large areas. FIG. 9 shows the order, the direction, the course, the start-out score points (X) and the ends of the cuts for cutting three glass plates A, B and C. The special complication in the separation task resides in the requirement that the cutting line No. 4 must not extend beyond the cutting line No. 2, that is, not into the glass plate A. But it is necessary that the score according to cutting line No. 4 extends almost exactly up to the cutting line No. 2 in order to provide a fault-free breaking edge. This can achieved with the method according to the invention, if it is made sure, that at the end of the cutting line No. 4, comparable energetic conditions are established as in the resonance state (during the startup score according to cutting line No. 4).

In this case, a scan line packet was employed which was built up from three parallel closely spaced individual lines. In order to reach the desired contour accuracy, the middle line, which was applied exactly on the desired separation line, additionally formed the guideline. This was done by the fact that the middle line No. 1 obtained twice the number of repetitions of the two side lines (No. 2 and No. 3) by observing the following scanning order: 1, 2, 1, 3, 1, 2, 1, 3, 1, 2 . . . )

The cutting parameters used for this triple-line packet were:

| | | |
|---|---|---|
| Start-out score speed | 6 | m/min |
| Laser power output | 580 | watts |
| Scanning speed | 9.6 | m/sec |
| Beam spot diameter | ca. 4.0 | mm |
| Scan length | 160 | mm |
| Advancement increment | 6 | mm |

| | |
|---|---|
| Number of repetitions increment | 80 per line packet |

d) The separation of edge strips from thick (8 and 12 mm) and especially thick (18.5 mm) glass plates is shown in FIG. 10. Herein, the special task resides in the generation of particularly deep start out scores in order to facilitate the subsequent backing procedure and to achieve a good separation area quality even with the difficult separation of a narrow edge strip of only 5 or, respectively, 10 cm width. FIG. 10 shows the course and the direction of the separating line and the position of the start-out score point in these 80 m by 60 m² large glass plates.

For the separation of a 5 cm wide glass strip with a 8 and 12 mm thick flat glass plate, the following cutting parameters were used:

| Startout Scoring speed | 2.4 | m/min |
|---|---|---|
| Laser power output | 600 | watts |
| Scoring speed | 12 | m/sec |
| Beam spot diameter | ca. 4.2 | mm |
| Scan length | 360 | mm |
| Advancement increment | 62 | mm |
| Number of repetitions | 180 | |
| Waiting time (time-distance be- | 5 | sec. |
| tween heating cooling) | | |

The score depth achieved in this way was in connection with the 8 mm thick glass plate 1.4 mm, with the 12 mm thick glass plate 1.6 mm.

The cutting parameters for the separation of a 10 cm wide glass strip from 18.5 mm thick glass were:

| Startout Scoring speed | 1.2 | m/min |
|---|---|---|
| Laser power output | 600 | watts |
| Scoring speed | 12 | m/sec |
| Beam spot diameter | ca. 4.2 | mm |
| Scan length | 360 | mm |
| Advancement increment | 2 | mm |
| Number of repetitions | 180 | |
| Waiting time (time-distance be- | 20 | sec. |
| tween heating cooling) | | |

The score depth achieved in this way was, with 18.5 mm thick glass, 2.2 mm.

e) The following example concerns the separation of laminated safety glass. This laminated safety glass has a highly non-symmetrical construction in that a thin glass plate is laminated via a PVB foil onto a thick glass plate. In the example presented here, the thin glass plate has a thickness of 2 mm, the thick glass plate has a thickness of 10 mm and the PVB foil has a thickness of 0.7 mm. The scoring of this laminated safety glass occurs in two steps, first on the thin glass plate and then on the thick glass plate wherein, the separation line in each case was guided in accordance with FIG. 10.

First, consequently, the thin glass plate was scored with the following cutting parameters:

| | | |
|---|---|---|
| scoring speed | 15 | m/min |
| Laser power output | 500 | watts |
| Scanning speed | 12 | m/s |
| Beam spot diameter | ca. 3.7 | mm |
| Scan length | 480 | mm |
| advancement increment | 2 | mm |

| | |
|---|---|
| Number of repetitions | 32 |

Then the laminated safety glass sheet was turned and adjusted exactly to the cutting line and then the thick glass plate was scored with the following cutting parameters:

| | | |
|---|---|---|
| Scoring speed | 8.0 | m/min |
| Laser power output | 600 | watts |
| Scanning speed | 12 | m/s |
| Beam spot diameter | ca. 4.0 | mm |
| Scan length | 480 | mm |
| Advancement increment | 2 | mm |

| | |
|---|---|
| Number of repetitions | 60 |

f) The last example concerns the cutting out of a circular glass plate. Here the technical procedure of applying an additional guide line resulted in the desired contour accuracy.

A circular glass plate with a diameter of 12 cm was cut from a 1.8=m thick square base glass plate of 15×15 cm² at a scoring speed of 15.0 m/min in a first step with the following cutting parameter:

| | | |
|---|---|---|
| Laser power output | 400 | watts |
| Scanning speed | 8 | m/s |
| Beam spot diameter | ca. 4.7 | mm |

| | |
|---|---|
| Scan length = | circle circumference |
| Number of repetitions | 30 |

Subsequently, as a second step, the additional guide line was applied with the following parameters:

| | | |
|---|---|---|
| Laser power output | 600 | watts |
| Scanning speed | 12 | m/s |
| Beam spot diameter | ca. 3.7 | mm |

| | |
|---|---|
| Scan length = | circle circumference |
| Number of repetitions | 8 |

Subsequent cooling occurred.

g) The technical feature of applying an additional guide line for cutting out the circular glass plate results in the desired contour accuracy of ±0.05 mm.

What is claimed is:

1. Method for separating flat glass sheets along a desired separation line by thermal scoring using a laser beam, said method comprising the steps of: at a start-out point, applying an initial score to the glass surface, moving the laser beam in the form of a beam spot from the start-out point over the glass surface along the desired separation line with a selected advancement speed, then cooling the line area of the glass surface previously laser-heated by a follow-up cooling nozzle, and guiding of the laser beam along the desired separation line in repetitive multiple passes along the desired separation line.

2. Method according to claim 1, wherein the heat energy amount applied by means of the laser beam per time unit to an area element of the glass surface is selected to be below a material specific limit value S_{g} in accordance with the formula:
$${S}_{q} = \frac{{P}_{1}}{d \cdot {v}_{5}} [ \frac{W \cdot S}{m {m}^{2}} ]$$
wherein P₁ is the laser power output, d is the beam spot diameter of the laser beam on the glass surface, and vₛ is the scanning speed (beam spot movement speed) of the laser beam over the glass surface.

3. Method according to claim 2, wherein the limit value S_{g} for the separation of float glass is maximally 0.016 Wₛ/mm².

4. Method according to claim 1, wherein the repetitive passing over the glass surface of the laser beam along the desired separation line occurs in the form of a small line packet of closely adjacent individual lines.

5. Method according to claim 4, wherein the individual lines are positioned energy-symmetrically with respect to the desired separation line.

6. Method according to claim 1, wherein a certain heating stretch distance along the desired separation line is each time passed over by the laser beam and this heating stretch is moved with each passing of the repetitive passing by the laser beam by an advancement increment Δx in cutting direction along the desired separation line.

7. Method according to claim 6, wherein the length of the advancement Δx is selected as a quotient of the length of the heating stretch and the selected number of the repetitive multiple scans by the laser beam.

8. Method according to claim 7, wherein between the repetitive scans of the glass surface by the laser beam, there is a short pause.

9. Method according to claim 8, wherein the pause duration for the separation of float glass is maximally 0.05 seconds.

10. Method according to claim 1, wherein the heat input to the glass surface by the laser beam occurs, with straight line desired separation lines, symmetrically to the desired separation line and, with curved desired separation lines, rotational-symmetrically about a line normal to the glass surface.

11. Method according to claim 10, wherein the symmetrical heat input occurs in such a way that the heat distribution has a maximum in the center, exactly on the desired separation line.

12. Method according to claim 11, wherein the centered heating maximum is generated by an additional scanned-in heating line in the form of a laser beam scan with reduced beam spot diameter serving as start-out score guide line.

13. Method according to claim 12, wherein the reduction of the beam spot diameter occurs by a displacement of the focusing lens system.

14. Method according to claim 1, wherein the cooling nozzle is guided in a time-based distance from the center point of the heating stretch generated by the laser beam scanning and moved in the cutting direction.

15. Method according to claim 14, wherein the time-based distance of the cooling nozzle from the heat stretch center point is selected to be proportional to the thickness of a flat glass sheet.

16. Method according to claim 1, wherein the cooling capacity is controlled to be proportional to the cutting speed and the glass thickness.

17. Method according to claim 1, wherein, by the selection of a large number of repetitions of the laser scanning, a deep scanning depth is generated.

18. Method according to claim 1, wherein, at the beginning and the end of the desired separation line, energetic conditions are generated comparable to those in the established state of the repetitive laser beam scans between the beginning and the end of the desired separation line.

19. Method according to claim 1, wherein, for format-cutting, at corners and intersections of desired separation lines, cutting occurs with cross-scores.
